(19) United States
(12) Patent Application Publication
(10) Pub. No.: US 2026/0129283 A1
(43) Pub. Date: May 7, 2026

(54) METHOD AND APPARATUS FOR OBTAINING CAMERA DATA, DEVICE AND READABLE-STORAGE MEDIUM

(71) Applicant: GOERTEK INC., Weifang (CN)

(72) Inventors: Jin WU, Weifang (CN); Mingming YANG, Weifang (CN); Baocheng LI, Weifang (CN); Yueqing CHEN, Weifang (CN); Xiugang WANG, Weifang (CN); Xudong QIU, Weifang (CN); Yaocheng LIU, Weifang (CN)

(21) Appl. No.: 19/426,832

(22) Filed: Dec. 19, 2025

Related U.S. Application Data
(63) Continuation of application No. PCT/CN2025/093111, filed on May 7, 2025.

(30) Foreign Application Priority Data
Jun. 26, 2024 (CN) 202410840940.5

(51) Int. Cl. H04N 23/63; H04N 23/661

(52) U.S. Cl. CPC H04N 23/632; H04N 23/661

(57) ABSTRACT

A method and an apparatus for obtaining camera data, an augmented reality device, and a storage medium. The method includes: receiving a camera access request and determining a target camera to be accessed based on the camera access request; turning on the target camera, in response to that the target camera is not turned on when the camera access request is received, obtaining a preview image stream captured by the turned-on target camera to obtain camera data of the target camera from the preview image stream, and sharing the preview image stream; and determining, in response to that the target camera is turned on when the camera access request is received, whether a quantity of processes currently accessing the target camera is less than or equal to a preset threshold.

### CROSS-REFERENCE TO RELATED APPLICATIONS

This application is a continuation application of International Application No. PCT/CN2025/093111, filed on May 7, 2025, which claims priority to Chinese Patent Application No. 202410840940.5, filed on Jun. 26, 2024. All of the aforementioned applications are incorporated herein by reference in their entireties.

### TECHNICAL FIELD

The present application relates to the technical field of augmented reality (AR), and in particular to a method and an apparatus for obtaining camera data, a device and a readable-storage medium.

### BACKGROUND

Augmented reality (AR) devices can overlay real-world environments and virtual videos onto the same screen or space in real time for the wearer to view. Common AR devices include AR glasses and AR helmets.

However, a camera on the current AR devices can only be used by one process at a time. That is, only one process is allowed to obtain the camera data captured by the camera. For example, if a camera of an AR device is used for gesture control, the same camera cannot be used for code-based recognition, object tracking, etc. When another process requests access to the camera, the device may employ a policy mechanism to determine whether to terminate the previous process's access so as to ensure that the camera is used exclusively by a single process.

### SUMMARY

The main purpose of the present application is to provide a method and an apparatus for obtaining camera data, a device and a readable-storage medium, which aims to solve the technical problem that a camera on current augmented reality (AR) devices can only be used by one process.

To achieve the above objectives, the present application provides a method for obtaining camera data, applied to an AR device. The method includes:
receiving a camera access request and determining a target camera to be accessed based on the camera access request;
turning on the target camera, in response to that the target camera is not turned on when the camera access request is received, obtaining a preview image stream captured by the turned-on target camera to obtain camera data of the target camera from the preview image stream, and sharing the preview image stream; and
determining, in response to that the target camera is turned on when the camera access request is received, whether a quantity of processes currently accessing the target camera is less than or equal to a preset threshold, and obtaining, in response to that the quantity of processes currently accessing the target camera is less than or equal to the preset threshold, the camera data of the target camera from the shared preview image stream.

In an embodiment, after the determining the target camera to be accessed based on the camera access request, the method further includes:
in response to that the target camera is turned on when the camera access request is received, and the quantity of processes currently accessing the target camera is greater than the preset threshold, determining a process to access the target camera based on the camera access request;
obtaining a priority of the process to access the target camera, and obtaining the priority of all processes currently accessing the target camera; and
determining a lowest priority among the priorities and terminating the process with the lowest priority.

In an embodiment, after the terminating the process with the lowest priority, the method further includes:
in response to that the terminated process is not a process that turned on the target camera, returning to the determining whether the quantity of processes currently accessing the target camera is less than or equal to the preset threshold; or
in response to that the terminated process is the process that turned on the target camera, determining a highest priority among the priorities, re-turning on the target camera based on the process with the highest priority, and returning to the obtaining the preview image stream captured by the turned-on target camera.

In an embodiment, the terminating the process with the lowest priority includes:
in response to that there are a plurality of processes currently accessing the target camera among the processes with the lowest priority, selecting the processes currently accessing the target camera among the processes with the lowest priority as candidate processes to be terminated; and
selecting at least one candidate process to be terminated as the target process from the candidate processes to be terminated, and terminating the target process.

In an embodiment, the selecting at least one candidate process to be terminated as the target process from the candidate processes to be terminated includes:
obtaining an initiation time of the access request corresponding to each of the candidate processes to be terminated; and
determining an earliest initiation time of the access request among the initiation times of each access request, and selecting the candidate process to be terminated corresponding to the earliest initiation time of the access request as the target process.

In an embodiment, the obtaining the preview image stream captured by the turned-on target camera includes:
initiating a preview request for the target camera; and
obtaining the preview image stream captured by the turned-on target camera based on the preview request.

In an embodiment, the obtaining the camera data of the target camera from the shared preview image stream includes:
obtaining configuration stream information based on the camera access request; and
based on the configuration stream information, obtaining the camera data of the target camera from the shared preview image stream.

In addition, to achieve the above objects, the present application further provides an apparatus for obtaining camera data, including:
a receiving module, configured to receive a camera access request and determine a target camera to be accessed based on the camera access request;
a sharing module, configured to turn on the target camera, in response to that the target camera is not turned on when the camera access request is received, obtain a preview image stream captured by the turned-on target camera to obtain camera data of the target camera from the preview image stream, and share the preview image stream; and
an acquisition module, configured to determine, in response to that the target camera is turned on when the camera access request is received, whether a quantity of processes currently accessing the target camera is less than or equal to a preset threshold, and obtain, in response to that the quantity of processes currently accessing the target camera is less than or equal to the preset threshold, the camera data of the target camera from the shared preview image stream.

In addition, to achieve the above objects, the present application further provides augmented reality device, including:
a memory; and
a processor,
a program for implementing the method for obtaining camera data is stored in the memory and executable on the processor, the program for implementing the method for obtaining camera data, when executed by the processor, implements the method for obtaining camera data as described above.

The present application further provides a non-transitory computer-readable storage medium, a program for implementing the method for obtaining camera data is stored on the computer-readable storage medium, the program for implementing the method for obtaining camera data is executed by a processor to implement the method for obtaining camera data as described above.

The present application further provides a computer program product, including a program for implementing the method for obtaining camera data, which, when executed by a processor, implements the method for obtaining camera data as described above.

In the present application, the AR device receive a camera access request and determine a target camera to be accessed based on the camera access request; turn on the target camera, in response to that the target camera is not turned on when the camera access request is received, obtain a preview image stream captured by the turned-on target camera to obtain camera data of the target camera from the preview image stream, and share the preview image stream; determine, in response to that the target camera is turned on when the camera access request is received, whether a quantity of processes currently accessing the target camera is less than or equal to a preset threshold, and obtain, in response to that the quantity of processes currently accessing the target camera is less than or equal to the preset threshold, the camera data of the target camera from the shared preview image stream. Thus, in the embodiment, upon receiving a camera access request, if the target camera is not turned on, the target camera is turned on and the preview image stream captured by the target camera is shared. This allows subsequent access requests from other processes to the target camera to be retrieved from the shared preview image stream, enabling a plurality of processes to obtain the camera data from the target camera based on the shared preview image stream. Consequently, a camera on the AR device can be used by a plurality of processes simultaneously.

### BRIEF DESCRIPTION OF THE DRAWINGS

The accompanying drawings, which are incorporated in and constitute a part of this specification, illustrate embodiments consistent with the present application and, together with the description, serve to explain the principles of the present application.

In order to more clearly illustrate the embodiments of the present application or the technical solutions in the related art, the following briefly introduces the drawings required for use in the embodiments or the description of the related art. Obviously, for those skilled in the art, other drawings can be obtained based on these drawings without any creative work.

FIG. 1 is a flowchart of a method for obtaining camera data according to a first embodiment of the present application.

FIG. 2 is a flowchart of the method for obtaining camera data according to a third embodiment of the present application.

FIG. 3 is a flowchart of the method for obtaining camera data according to the third embodiment of the present application.

FIG. 4 is a flowchart of the method for obtaining camera data according to the third embodiment of the present application.

FIG. 5 is a flowchart of the method for obtaining camera data according to the third embodiment of the present application.

FIG. 6 is a flowchart of a process of turning on the camera according to an embodiment of the present application.

FIG. 7 is a flowchart of the process performing configuration streaming according to an embodiment of the present application.

FIG. 8 is a schematic diagram of an apparatus for obtaining camera data according to an embodiment of the present application.

FIG. 9 is a schematic diagram of a hardware operating environment involved in the apparatus for obtaining camera data according to an embodiment of the present application.

The purpose, features and advantages of the present application will be further explained with reference to the accompanying drawings in conjunction with the embodiments.

### DETAILED DESCRIPTION OF THE EMBODIMENTS

To make the above-mentioned objects, features, and advantages of the present application more apparent and understandable, the technical solutions of the embodiments of the present application will be clearly and completely described below with reference to the accompanying drawings. Obviously, the described embodiments are only some embodiments of the present application, and not all embodiments. Based on the embodiments of the present application, all other embodiments obtained by those skilled in the art without creative effort are within the scope of protection of the present application.

The main solution of the present application is as follows: receiving a camera access request and determining a target camera to be accessed based on the camera access request; turning on the target camera, in response to that the target camera is not turned on when the camera access request is received, obtaining a preview image stream captured by the turned-on target camera to obtain camera data of the target camera from the preview image stream, and sharing the preview image stream; determining, in response to that the target camera is turned on when the camera access request is received, whether a quantity of processes currently accessing the target camera is less than or equal to a preset threshold; and obtaining, in response to that the quantity of processes currently accessing the target camera is less than or equal to the preset threshold, the camera data of the target camera from the shared preview image stream.

In the technical solution of the present application, after receiving a camera access request, if the target camera is not turned on, then the target camera is turned on and the preview image stream captured by the target camera is shared. This allows subsequent access requests from other processes to the target camera to retrieve the camera data from the shared preview image stream. Thus, based on the shared preview image stream, a plurality of processes can access the camera data of the target camera, enabling a camera on the augmented reality (AR) device to be used by a plurality of processes simultaneously.

It should be noted that the execution subject of the embodiment can be a computing service device with data processing, network communication and program running functions, such as a tablet computer, personal computer, mobile phone, etc., or an augmented reality device that can realize the above functions, such as AR glasses, AR helmet, etc. For example, AR glasses are used as the execution subject to describe the various embodiments of the present application.

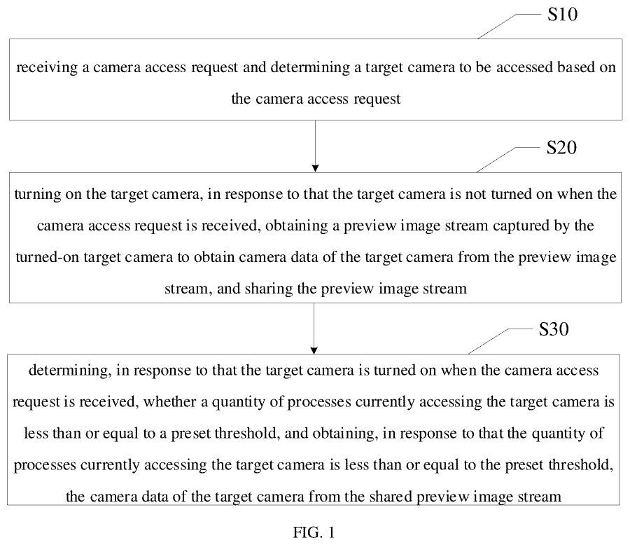

Based on this, a method for obtaining camera data according to a first embodiment, as shown in FIG. 1, the method for obtaining camera data includes steps S10 to S30.

Step S10, receiving a camera access request and determining a target camera to be accessed based on the camera access request.

It should be noted that the AR glasses can be AR glasses based on the Android camera system.

When a specific camera needs to be used, a camera access request can be initiated for that camera. In an embodiment, the camera's identifier can be encapsulated in the camera access request to determine the target camera to be accessed.

It should be noted that after a process initiates a camera access request to the target camera, if the process's access request to the target camera is accepted, the process can obtain the camera data of the target camera. That is, the process starts using the target camera. During the use of the target camera, the process will not send any more camera access requests. It only needs to initiate a camera stop access request to terminate the process when the process no longer needs to use the target camera, so that the process cannot obtain the camera data of the target camera, that is, the process cannot use the target camera.

It is understood that, at the operating system level, an application (or application program) executes tasks through processes. For example, in AR glasses, application A accesses the target camera. At the operating system level, application A actually executes the task of accessing the target camera through a process. Based on this, the processes described in the embodiments of the present application can be understood as applications.

Step S20, turning on the target camera, in response to that the target camera is not turned on when the camera access request is received, obtaining a preview image stream captured by the turned-on target camera to obtain camera data of the target camera from the preview image stream, and sharing the preview image stream.

The preview image stream is an image stream composed of image frames captured by the target camera based on a preset shooting frequency.

The Android camera system architecture includes, in sequence, the application layer, the framework layer, the hardware abstraction layer (HAL), and the hardware layer. The framework layer provides functions such as querying camera device information, opening the camera device, and monitoring camera status changes. The OpenCamera process in the framework layer is initiated to open the target camera. During the process, the system requests a configuration stream object to request configuration stream information from the HAL layer, including image format, color space, resolution, and the HAL pipeline. Once the configuration stream information is configured, a configuration stream is obtained. After receiving the configuration stream object, i.e., after the configuration stream information is configured, the preview image stream captured by the target camera can be obtained through the configuration stream object. In an embodiment, the preview image stream is obtained through the pipeline in the configuration stream. The pipeline is a component of the HAL layer used to manage the flow of image data from image sensors (such as cameras) to applications. It ensures that image data is transmitted in an efficient and consistent manner, while handling data format conversions. The pipeline may include a plurality of processing stages, such as noise reduction, white balance adjustment, color correction, cropping, scaling, etc. These processing stages help improve image quality and meet the needs of applications.

The camera data of the target camera is obtained from the preview image stream. In an embodiment, one frame, a plurality of frames, or all frames can be obtained from the preview image stream as the camera data of the target camera. It is easy to understand that different processes have different requirements for the quantity of image frames they need to obtain. For example, the gesture recognition process may need to obtain all image frames, while the photo capture process may only need to obtain one image frame. Based on this, the corresponding image frame can be obtained from the preview image stream as the obtained camera data based on the characteristics of the process itself.

In an embodiment, the sharing the preview image stream includes: a stream access interface of the preview image stream can be shared so that other processes can access the preview image stream through the shared stream access interface.

Step S30, determining, in response to that the target camera is turned on when the camera access request is received, whether a quantity of processes currently accessing the target camera is less than or equal to a preset threshold, and obtaining, in response to that the quantity of processes currently accessing the target camera is less than or equal to the preset threshold, the camera data of the target camera from the shared preview image stream.

Considering the limited quantity of configuration streams allowed by the HAL layer (e.g., only 3), and that each process needs to obtain the image stream through these configuration streams. Based on this, the preset threshold is set to the quantity of configuration streams allowed by the AR glasses. This ensures successful configuration of the configuration streams, thereby guaranteeing that the process can successfully obtain the image stream.

The process currently accessing the target camera is the process currently using the target camera.

If the quantity of processes currently accessing the target camera exceeds a preset threshold, the quantity of configuration streams configured in the AR glasses is approaching or has reached its limit, making further configuration impossible. In this case, the process initiating the camera access request may fail to obtain the image stream due to configuration stream limitations. Therefore, the process's camera access request can be rejected, or at least one process currently accessing the target camera can be terminated to release its configuration stream, allowing the process initiating the request to successfully complete configuration and obtain the image stream. Furthermore, considering that the process that turned on the target camera is the provider of the preview image stream, the process that turned on the target camera can be not terminated to ensure the continuous provision of the preview image stream.

It's important to note that in the Android camera system architecture, after the HAL layer returns image stream data, the image stream data can be passed to the framework layer via a Surface object or an ImageReader object, and then transmitted to the application layer for use by the application. The Surface object is an interface layer located between the framework layer and the HAL, managed by Android's window management system, and used for graphics rendering and media playback. The ImageReader object is an interface for receiving image data; it's part of the Camera2 API and allows applications to directly access image data for further processing, such as real-time preview, taking photos, and video recording. Therefore, image streams can be read using either the Surface object or the ImageReader object.

In the embodiment, the AR glasses receive a camera access request and determine a target camera to be accessed based on the camera access request; turn on the target camera, in response to that the target camera is not turned on when the camera access request is received, obtain a preview image stream captured by the turned-on target camera to obtain camera data of the target camera from the preview image stream, and share the preview image stream; determine, in response to that the target camera is turned on when the camera access request is received, whether a quantity of processes currently accessing the target camera is less than or equal to a preset threshold, and obtain, in response to that the quantity of processes currently accessing the target camera is less than or equal to the preset threshold, the camera data of the target camera from the shared preview image stream. Thus, in the embodiment, after receiving a camera access request, if the target camera is not turned on, then the target camera is turned on and the preview image stream captured by the target camera is shared. This allows subsequent access requests from other processes to the target camera to retrieve the camera data from the shared preview image stream. Thus, based on the shared preview image stream, a plurality of processes can access the camera data of the target camera, enabling a camera on the AR device to be used by a plurality of processes simultaneously, i.e., sharing the camera of the AR glasses.

Based on the first embodiment of the present application, in the second embodiment of the present application, the content that is the same as or similar to that in the first embodiment described above can be referred to the above description and will not be repeated hereafter. Based on this, the obtaining the preview image stream captured by the turned-on target camera includes:

Step A10, initiating a preview request for the target camera, and obtaining the preview image stream captured by the turned-on target camera based on the preview request.

In the embodiment, even if the process that turned on the target camera does not request to enable preview, it actively initiates a preview request for the target camera to obtain a real-time preview image of the target camera, thereby providing a shared data foundation for sharing the target camera. That is, the preview image stream is a real-time preview image of the target camera, containing all the image data captured by the target camera, so subsequent processes that share and use the target camera can obtain the required image data from the preview image stream.

In an embodiment, the obtaining the shared preview image stream includes:

Step B10, obtaining configuration stream information based on the camera access request; and based on the configuration stream information, obtaining the camera data of the target camera from the shared preview image stream.

The configuration stream information includes, but is not limited to, image format, color space, resolution, and HAL pipeline. Image parameters such as image format, color space, and resolution can be encapsulated in the camera access request. These image parameters can be obtained by decapsulating the camera access request. The HAL pipeline is generated by the system and can be understood as the pipeline for transmitting preview image streams.

Obtaining the shared preview image stream based on the configuration stream information can include: obtaining the preview image stream through the pipeline in the configuration stream information. The actual obtained image stream can be understood as the stream data output after the preview image stream passes through the pipeline.

In an embodiment, the configuration stream information can be merged into the configuration stream object created by the process that turned on the target camera, thereby updating the configuration stream in the configuration stream object. This allows subsequent processes to use a unified configuration stream object to obtain image stream data. Furthermore, for a given process, the preview image stream is obtained using the configuration stream information corresponding to that process, ensuring that the obtained image stream is the expected format of the stream data.

After obtaining the image stream through the pipeline in the configuration stream information, one, a plurality of, or all frames of the image stream can be further obtained as the camera data for the target camera. It's easy to understand that different processes have different requirements for the image frames they need to obtain, and the corresponding image frames can be obtained from the image stream based on the characteristics of the process itself as the obtained camera data.

Based on the first and/or second embodiments of the present application, in the third embodiment of the present application, the content that is the same as or similar to the first and second embodiments described above can be referred to the above description and will not be repeated hereafter. Based on this, as shown in FIG. 2, after the determining the target camera to be accessed based on the camera access request, the method further includes:

Step C10, in response to that the target camera is turned on when the camera access request is received, and the quantity of processes currently accessing the target camera is greater than the preset threshold, determining a process to access the target camera based on the camera access request.

In an embodiment, a process identifier can be encapsulated in the camera access request to identify the process represented by the process identifier as the process to access the target camera.

Step C20, in response to that the target camera is turned on when the camera access request is received, and the quantity of processes currently accessing the target camera is greater than the preset threshold, determining a process to access the target camera based on the camera access request.

Process priority information can be preset in advance. The priority information includes priority setting rules and/or priority adjustment rules, such as the priority of a process is reduced by one level when it accesses the target camera. Based on the preset priority information, the priority of the process to access the target camera, as well as the priority of all processes currently accessing the target camera, can be obtained.

For ease of explanation and clarification, the priority of the process to access the target camera will be used as the first priority, and the priority of the process currently accessing the target camera will be used as the second priority.

Step C30, determining a lowest priority among the priorities and terminating the process with the lowest priority.

The lowest priority among all priorities, that is, the lowest priority between the first priority and the second priority.

To terminate the lowest priority process, one or more processes with the lowest priority can be terminated. Furthermore, if any of the lowest priority processes are currently accessing the target camera, then one or more of these lowest priority processes currently accessing the target camera are terminated, thereby terminating their access to the target camera and ending their use of it. The processes can also be randomly selected for termination, or they can be selected based on preset rules (such as the process that initiated the camera access request first, the process that initiated the camera access request last, etc.).

If there is no process currently accessing the target camera in the lowest priority process, that is, the process to access the target camera has the lowest priority, then the process is terminated. That is, the camera access request of the process is rejected.

In the embodiment, when the quantity of processes currently accessing the target camera is greater than a preset threshold, the process with the lowest priority is terminated, thereby ensuring that high-priority processes can use the camera first.

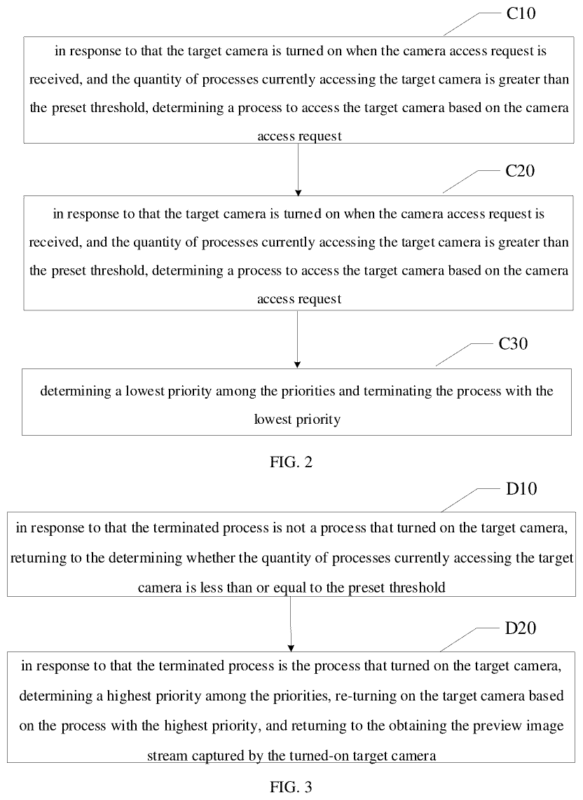

In an embodiment, as shown in FIG. 3, after the terminating the process with the lowest priority, the method further includes:

Step D10, in response to that the terminated process is not a process that turned on the target camera, returning to the determining whether the quantity of processes currently accessing the target camera is less than or equal to the preset threshold.

If the terminated process is not the process that turned on the target camera, the process that turned on the target camera will continue to provide a preview image stream so that other processes can share the camera data obtained from the target camera.

Furthermore, if the terminated process is not the process that initiated the camera access request this time, that is, not the process to access the target camera this time, then the process returns to the determining whether the quantity of processes currently accessing the target camera is less than or equal to the preset threshold. After the process currently accessing the target camera is terminated, the process to access the target camera this time can obtain the camera data of the target camera from the shared preview image stream, thereby responding to the camera access request of the process in time.

Step D20, in response to that the terminated process is the process that turned on the target camera, determining a highest priority among the priorities, re-turning on the target camera based on the process with the highest priority, and returning to the obtaining the preview image stream captured by the turned-on target camera.

If the terminated process is the process that turned on the target camera, then the target camera will be re-turned on based on the process with the highest process priority. It should be noted that if there are a plurality of processes with the highest process priority, the process with the highest priority can be selected to re-turn on the target camera, thus providing the preview image stream again through the process that re-turned on the target camera. Furthermore, the highest priority process is selected to re-turn on the target camera to reduce the probability of that process being forcibly terminated subsequently.

Furthermore, if the process that turned on the target camera actively relinquishes its use of the target camera and initiates a request to stop accessing the camera, the process with the highest priority among the processes currently accessing the target camera can be selected to re-turn on the target camera, so that the preview image stream can be provided again through the process that re-turned on the target camera.

In an embodiment, as shown in FIG. 4, the terminating the process with the lowest priority includes:

Step E10, in response to that there are a plurality of processes currently accessing the target camera among the processes with the lowest priority, selecting the processes currently accessing the target camera among the processes with the lowest priority as candidate processes to be terminated.

Step E20, selecting at least one candidate process to be terminated as the target process from the candidate processes to be terminated, and terminating the target process.

In an embodiment, one candidate process to be terminated is selected as the target process so that as many processes as possible can share the use of the camera, thereby ensuring that as many applications as possible in the AR glasses can run normally.

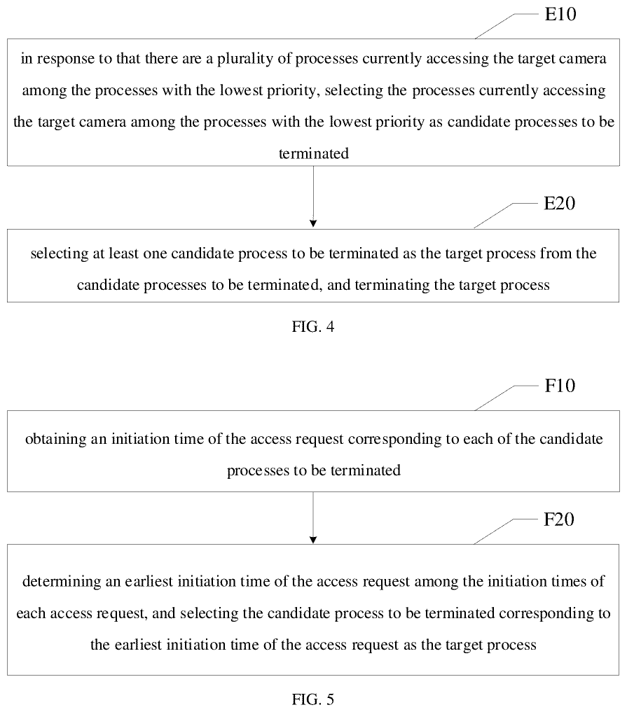

In an embodiment, as shown in FIG. 5, the selecting at least one candidate process to be terminated as the target process from the candidate processes to be terminated includes:

Step F10, obtaining an initiation time of the access request corresponding to each of the candidate processes to be terminated.

The initiation time of the access request represents the time when a process initiates a camera access request. In an embodiment, the time when the process receives the camera access request can be used as the initiation time of the access request for that process. In an embodiment, when a process initiates a camera access request, the initiation time of the camera access request is encapsulated in the camera access request, thus the initiation time of the access request for that process is obtained through the camera access request.

Step F20, determining an earliest initiation time of the access request among the initiation times of each access request, and selecting the candidate process to be terminated corresponding to the earliest initiation time of the access request as the target process.

In the embodiment, the process with the earliest initiation time of the access request is selected as the target process. That is, when the priorities are the same, the process is terminated according to the first-in-first-out principle, which ensures that each process uses the camera for a relatively balanced amount of time, and also avoids the situation where a new process eliminates the camera as soon as it is used and then cannot continue to use the camera.

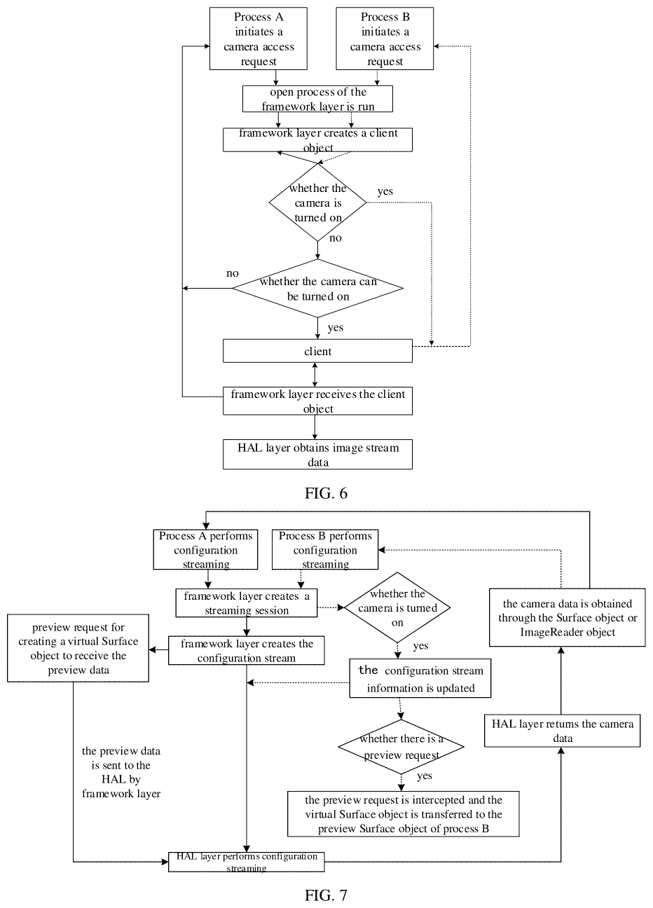

For example, to aid in understanding the technical concept or principle of obtaining camera data based on the combination of the above-described first and second embodiments, an embodiment is provided. In the embodiment, as shown in FIG. 6 and FIG. 7, it is assumed that two processes need to share the use of a camera, such as process A (application A) and process B (application B).

Process A (application A): the system uses camera data in the background and does not require previewing.

Process B (application B): a third party uses camera data (a preview request is optional).

Process A first initiates a camera access request, as shown in FIG. 6 and FIG. 7, the solid lines represent the flow of process A, and the dashed lines represent the flow of process B. Based on this, the camera data acquisition process is as follows:

### Process A

(1) Process A initiates a camera access request, at this time, the camera is not turned on. Process A requests to turn on the camera and runs the open process of the framework layer. If the camera is not turned on and it is allowed to start the camera, then the camera is turned on and a client object (also called a camera object) is requested from the HAL layer. When the framework layer receives the client object returned by the HAL layer, it considers process A to be a qualified client that can obtain image stream data from the HAL layer. At the same time, when a camera is not turned on and is requested to be turned on by a process, there are two situations: the preview request is enabled or the preview request is not enabled. If the preview request is enabled, it will be executed normally. If the preview request is not enabled, a preview request for the camera is sent to the HAL layer so that the HAL layer returns the obtained image stream (i.e., camera data) from the camera. The framework layer creates a virtual Surface object to receive the preview image stream (i.e., preview data).

(2) The image stream returned by HAL is obtained through the Surface object or ImageReader object.

### Process B

(1) Process B initiates a camera access request and modifies the contention mechanism. At this time, by running the open process in the framework layer, process B founds the camera is already turned on, and the client object of process A is given to process B, so that process B no longer needs to request it from the HAL layer. That is, the access of process B is switched to the client access of process A.

(2) After process B obtains the camera object, it continues to create a streaming session and sends the configuration stream information to the system.

(3) If the system determines that there is already a configuration stream object (the configuration stream object created by process A), then the current configuration stream information is merged into the previous configuration stream object. After the configuration stream is successfully configured, if there is a preview request, then the preview request is intercepted and the virtual Surface object created by process A is transferred to the preview Surface object of process B.

(4) The image stream (i.e. camera data) returned by HAL is obtained through the Surface object or ImageReader object.

If process C needs to use the camera simultaneously, a contention mechanism is activated. That is, process A is retained, process B is eliminated, process C continues, and the operation of process B is repeated.

In the embodiment, the system refers to the Android camera system.

It should be noted that the above specific embodiments are only used to understand the present application and do not constitute a limitation on the camera data acquisition process of the present application. Any simple modifications based on this technical concept are all within the protection scope of the present application.

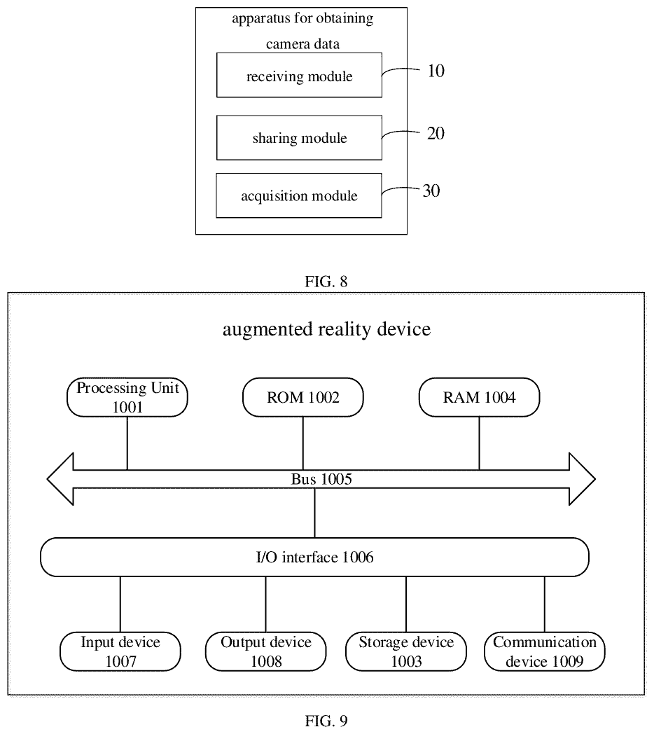

Furthermore, an embodiment of the present application also provides an apparatus for obtaining camera data. As shown in FIG. 8, the apparatus for obtaining camera data includes a receiving module 10, a sharing module 20 and an acquisition module 30.

The receiving module 10 is configured to receive a camera access request and determine a target camera to be accessed based on the camera access request.

The sharing module 20 is configured to turn on the target camera, in response to that the target camera is not turned on when the camera access request is received, obtain a preview image stream captured by the turned-on target camera to obtain camera data of the target camera from the preview image stream, and share the preview image stream.

The acquisition module 30 is configured to determine, in response to that the target camera is turned on when the camera access request is received, whether a quantity of processes currently accessing the target camera is less than or equal to a preset threshold, and obtain, in response to that the quantity of processes currently accessing the target camera is less than or equal to the preset threshold, the camera data of the target camera from the shared preview image stream.

In an embodiment, the apparatus for obtaining camera data further includes a termination module, the termination module is configured to determine a process to access the target camera based on the camera access request in response to that the target camera is turned on when the camera access request is received, and the quantity of processes currently accessing the target camera is greater than the preset threshold; obtain a priority of the process to access the target camera, and obtain the priority of all processes currently accessing the target camera; and determine a lowest priority among the priorities and terminate the process with the lowest priority.

In an embodiment, the apparatus for obtaining camera data is further configured to in response to that the terminated process is not a process that turned on the target camera, return to the determine whether the quantity of processes currently accessing the target camera is less than or equal to the preset threshold; or, in response to that the terminated process is the process that turned on the target camera, determine a highest priority among the priorities, re-turn on the target camera based on the process with the highest priority, and return to the obtain the preview image stream captured by the turned-on target camera.

In an embodiment, the termination module is further configured to select the processes currently accessing the target camera among the processes with the lowest priority as candidate processes to be terminated, in response to that there are a plurality of processes currently accessing the target camera among the processes with the lowest priority; and select at least one candidate process to be terminated as the target process from the candidate processes to be terminated, and terminate the target process.

In an embodiment, the termination module is further configured to obtain an initiation time of the access request corresponding to each of the candidate processes to be terminated; and determine an earliest initiation time of the access request among the initiation times of each access request, and select the candidate process to be terminated corresponding to the earliest initiation time of the access request as the target process.

In an embodiment, the sharing module 20 is further configured to initiate a preview request for the target camera; and obtain the preview image stream captured by the turned-on target camera based on the preview request.

In an embodiment, the acquisition module 10 is further configured to obtain configuration stream information based on the camera access request; and based on the configuration stream information, obtain the camera data of the target camera from the shared preview image stream.

Furthermore, an embodiment of the present application further proposes an augmented reality device, which includes a memory and a processor. A program for implementing the method for obtaining camera data is stored in the memory and executable on the processor. When the program for implementing the method for obtaining camera data is executed by the processor, it implements the method for obtaining camera data described above.

Furthermore, as shown in FIG. 9, the augmented reality device may also include a processing unit 1001 (e.g., a central processing unit, a graphics processing unit, etc.), which can perform various appropriate actions and processes according to a program stored in read-only memory (ROM) 1002 or a program loaded from storage device 1003 into random access memory (RAM) 1004. The RAM 1004 also stores various programs and data required for the operation of the augmented reality device. The processing unit 1001, ROM 1002, and RAM 1004 are interconnected via a bus 1005. An input/output (I/O) interface 1006 is also connected to the bus. Typically, the following systems can be connected to the I/O interface 1006: input devices 1007 including, for example, touchscreens, touchpads, image sensors, microphones, accelerometers, gyroscopes, etc.; output devices 1008 including, for example, liquid crystal displays (LCDs), speakers, vibrators, etc.; storage devices 1003 including, for example, magnetic tapes, hard disks, etc.; and communication devices 1009. The communication device 1009 allows the augmented reality device to communicate wirelessly or wiredly with other devices to exchange data. While the figures show augmented reality devices with various systems, it should be understood that implementing or having all of the systems shown is not required. More or fewer systems may be implemented alternatively.

In an embodiment, according to the embodiments disclosed in the present application, the processes described above with reference to the flowcharts can be implemented as computer software programs. For example, embodiments disclosed in the present application include a computer program product including a computer program carried on a computer-readable medium, the computer program containing program code for performing the methods shown in the flowcharts. In such embodiments, the computer program can be downloaded and installed from a network via a communication device, or installed from storage device 1003, or installed from ROM 1002. When the computer program is executed by processing unit 1001, it performs the functions defined in the methods of the embodiments disclosed in the present application.

The augmented reality device provided in the present application, employing the method for obtaining camera data described in the above embodiments, can solve the technical problem of camera data acquisition. Compared with the related art, the beneficial effects of the augmented reality device provided in the present application are the same as those of the method for obtaining camera data provided in the above embodiments, and other technical features of the augmented reality device are the same as those disclosed in the method of the previous embodiment, and will not be repeated here.

It should be understood that the various parts disclosed in the present application can be implemented using hardware, software, firmware, or a combination thereof. In the description of the above embodiments, specific features, structures, materials, or characteristics can be combined in any suitable manner in one or more embodiments or examples.

The above description is merely some embodiments of the present application, but the scope of protection of the present application is not limited thereto. Any variations or substitutions that can be easily conceived by those skilled in the art within the scope of the technology disclosed in the present application should be included within the scope of protection of the present application. Therefore, the scope of protection of the present application should be determined by the scope of the claims.

In addition, to achieve the above objectives, the present application also provides a non-transitory computer-readable storage medium including computer-readable program instructions (i.e., a computer program) stored thereon, which are configured to execute the method for obtaining camera data in the above embodiments.

The computer-readable storage medium provided in the present application embodiment may be, for example, a universal serial bus (USB) flash drive, but is not limited to, electrical, magnetic, optical, electromagnetic, infrared, or semiconductor systems, devices, or any combination thereof. More specific examples of computer-readable storage media may include, but are not limited to: electrical connections with one or more wires, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination thereof. In the embodiment, the computer-readable storage medium may be any tangible medium containing or storing a program that can be used by or in conjunction with an instruction execution system, system, or device. The program code contained on the computer-readable storage medium may be transmitted using any suitable medium, including but not limited to: wires, optical cables, radio frequency (RF), etc., or any suitable combination thereof.

The aforementioned computer-readable storage medium may be included in the augmented reality device; or it may exist independently and not incorporated into the augmented reality device.

The aforementioned computer-readable storage medium carries one or more programs that, when executed by an augmented reality device, cause the augmented reality device to: receive a camera access request and determine a target camera to be accessed based on the camera access request; turn on the target camera, in response to that the target camera is not turned on when the camera access request is received, obtain a preview image stream captured by the turned-on target camera to obtain camera data of the target camera from the preview image stream, and share the preview image stream; determine, in response to that the target camera is turned on when the camera access request is received, whether a quantity of processes currently accessing the target camera is less than or equal to a preset threshold, and obtain, in response to that the quantity of processes currently accessing the target camera is less than or equal to the preset threshold, the camera data of the target camera from the shared preview image stream.

Computer program code for performing the operations of the present application can be written in one or more programming languages or a combination thereof, including object-oriented programming languages such as Java, Smalltalk, and C++, and conventional procedural programming languages such as the “C” language or similar programming languages. The program code can be executed entirely on the user's computer, partially on the user's computer, as a standalone software package, partially on the user's computer and partially on a remote computer, or entirely on a remote computer or server. In cases involving remote computers, the remote computer can be connected to the user's computer via any type of network-including a Local Area Network (LAN) or a Wide Area Network (WAN)-or can be connected to an external computer (e.g., via the Internet using an Internet service provider).

The flowcharts and block diagrams in the accompanying drawings illustrate the architecture, functionality, and operation of possible implementations of systems, methods, and computer program products according to various embodiments of the present application. In this regard, each block in a flowchart or block diagram may represent a module, segment, or portion of code containing one or more executable instructions for implementing a specified logical function. It should also be noted that in some alternative implementations, the functions indicated in the blocks may occur in a different order than those indicated in the drawings. For example, two consecutively indicated blocks may actually be executed substantially in parallel, and they may sometimes be executed in reverse order, depending on the functions involved. It should also be noted that each block in the block diagrams and/or flowcharts, and combinations of blocks in the block diagrams and/or flowcharts, can be implemented using a dedicated hardware-based system that performs the specified function or operation, or using a combination of dedicated hardware and computer instructions.

The modules described in the embodiments of the present application can be implemented in software or hardware. The names of the modules do not necessarily limit the functionality of the unit itself.

The readable storage medium provided in the present application is a computer-readable storage medium that stores computer-readable program instructions (i.e., a computer program) for executing the above-described method for obtaining camera data, thereby solving the technical problem of camera data acquisition. Compared with the related art, the beneficial effects of the computer-readable storage medium provided in the present application are the same as those of the method for obtaining camera data provided in the above embodiments, and will not be repeated here.

Furthermore, the present application further provides a computer program product, including a program for implementing the method for obtaining camera data, which, when executed by a processor, implements the method for obtaining camera data described above.

The embodiment of the computer program product in the present application is basically the same as the embodiments of the above-described method for obtaining camera data, and will not be repeated here.

It should be noted that, in this document, the terms “comprising”, “including” or any other variations thereof are intended to cover non-exclusive inclusion, such that a process, method, article, or system that comprises a list of elements includes not only those elements but also other elements not expressly listed, or elements inherent to such a process, method, article, or system. Unless otherwise specified, an element defined by the phrase “comprising one . . . ” does not exclude the presence of other identical elements in the process, method, article, or system that includes that element.

In the present application are for descriptive purposes only and do not represent the superiority or inferiority of the embodiments.

Through the above description of the embodiments, those skilled in the art can clearly understand that the methods of the above embodiments can be implemented by means of software plus necessary general-purpose hardware platforms. They can also be implemented by hardware, but in many cases the former is a better implementation method. Based on this understanding, the technical solution of the present application, in essence, or the part that contributes to the related art, can be embodied in the form of a software sensor. This computer software sensor is stored in a storage medium (such as ROM/RAM, magnetic disk, optical disk) as described above, and includes several instructions to cause a terminal device (which may be a mobile phone, computer, server, air conditioner, or network device, etc.) to execute the methods described in the various embodiments of the present application.

The above are merely preferred embodiments of the present application and do not limit the patent scope of the present application. Any equivalent structural or procedural transformations made using the content of the specification and drawings of the present application, or direct or indirect applications in other related technical fields, are similarly included within the patent protection scope of the present application.

What is claimed is:

1. A method for obtaining camera data, applied to an augmented reality device, comprising:
receiving a camera access request and determining a target camera to be accessed based on the camera access request;
turning on the target camera, in response to that the target camera is not turned on when the camera access request is received, obtaining a preview image stream captured by the turned-on target camera to obtain camera data of the target camera from the preview image stream, and sharing the preview image stream; and
determining, in response to that the target camera is turned on when the camera access request is received, whether a quantity of processes currently accessing the target camera is less than or equal to a preset threshold, and obtaining, in response to that the quantity of processes currently accessing the target camera is less than or equal to the preset threshold, the camera data of the target camera from the shared preview image stream.

2. The method according to claim 1, wherein after the determining the target camera to be accessed based on the camera access request, the method further comprises:
in response to that the target camera is turned on when the camera access request is received, and the quantity of processes currently accessing the target camera is greater than the preset threshold, determining a process to access the target camera based on the camera access request;
obtaining a priority of the process to access the target camera, and obtaining the priority of all processes currently accessing the target camera; and
determining a lowest priority among the priorities and terminating the process with the lowest priority.

3. The method according to claim 2, wherein after the terminating the process with the lowest priority, the method further comprises:
in response to that the terminated process is not a process that turned on the target camera, returning to the determining whether the quantity of processes currently accessing the target camera is less than or equal to the preset threshold; or
in response to that the terminated process is the process that turned on the target camera, determining a highest priority among the priorities, re-turning on the target camera based on the process with the highest priority, and returning to the obtaining the preview image stream captured by the turned-on target camera.

4. The method according to claim 2, wherein the terminating the process with the lowest priority comprises:
in response to that there are a plurality of processes currently accessing the target camera among the processes with the lowest priority, selecting the processes currently accessing the target camera among the processes with the lowest priority as candidate processes to be terminated; and
selecting at least one candidate process to be terminated as the target process from the candidate processes to be terminated, and terminating the target process.

5. The method according to claim 4, wherein the selecting at least one candidate process to be terminated as the target process from the candidate processes to be terminated comprises:
obtaining an initiation time of the access request corresponding to each of the candidate processes to be terminated; and
determining an earliest initiation time of the access request among the initiation times of each access request, and selecting the candidate process to be terminated corresponding to the earliest initiation time of the access request as the target process.

6. The method according to claim 1, wherein the obtaining the preview image stream captured by the turned-on target camera comprises:
initiating a preview request for the target camera; and
obtaining the preview image stream captured by the turned-on target camera based on the preview request.

7. The method according to claim 1, wherein the obtaining the camera data of the target camera from the shared preview image stream comprises:
obtaining configuration stream information based on the camera access request; and
based on the configuration stream information, obtaining the camera data of the target camera from the shared preview image stream.

8. An apparatus for obtaining camera data, comprising:
a receiving module, configured to receive a camera access request and determine a target camera to be accessed based on the camera access request;
a sharing module, configured to turn on the target camera, in response to that the target camera is not turned on when the camera access request is received, obtain a preview image stream captured by the turned-on target camera to obtain camera data of the target camera from the preview image stream, and share the preview image stream; and
an acquisition module, configured to determine, in response to that the target camera is turned on when the camera access request is received, whether a quantity of processes currently accessing the target camera is less than or equal to a preset threshold, and obtain, in response to that the quantity of processes currently accessing the target camera is less than or equal to the preset threshold, the camera data of the target camera from the shared preview image stream.

9. An augmented reality device, comprising:
a memory; and
a processor,
wherein a program for implementing the method for obtaining camera data is stored in the memory and executable on the processor, the program for implementing the method for obtaining camera data, when executed by the processor, implements the method for obtaining camera data according to claim 1.

10. A non-transitory computer-readable storage medium, wherein a program for implementing the method for obtaining camera data is stored on the computer-readable storage medium, the program for implementing the method for obtaining camera data is executed by a processor to implement the method for obtaining camera data according to claim 1.
